(19) United States
(12) Patent Application Publication
(10) Pub. No.: US 2022/0341144 A1
(43) Pub. Date: Oct. 27, 2022

(54) Septic Aid

(71) Applicants: Michelle Loyer, Van Wert, OH (US); Hope Loyer, Van Wert, OH (US); Darrian Hoerig, Fort Worth, TX (US)

(72) Inventors: Michelle Loyer, Van Wert, OH (US); Hope Loyer, Van Wert, OH (US); Darrian Hoerig, Fort Worth, TX (US)

(21) Appl. No.: 17/724,788

(22) Filed: Apr. 20, 2022

Related U.S. Application Data
(60) Provisional application No. 63/177,448, filed on Apr. 21, 2021.

(51) Int. Cl. E03D 9/03; C02F 3/34

(52) U.S. Cl. CPC E03D 9/032; E03D 9/038; C02F 3/348; C02F 2103/005

(57) ABSTRACT

A Septic Aid system includes at least tablet containing dissolvable septic treatment so constituted as to supply a septic system with replacement bacteria and/or enzymes. The at least one tablet is configured to slowly release the septic treatment into toilet water. The at least one tablet may also have a dissolvable color indicator configured to run out at approximately the same time as the dissolvable septic treatment is depleted. An attachment may be provided in the form of an adhesive disc, suction cup, or hangar. An applicator may be used to apply the at least one tablet to an interior surface of the toilet.

### Cross-Reference to Related Applications

The present application claims priority to U.S. Provisional Application No. 63/177,448 filed Apr. 21, 2021, the entire contents of all of which are herein incorporated by reference.

### BACKGROUND

### Field of Invention

Embodiments of the present invention described herein generally relate to a Septic Aid. The Septic Aid is a tablet that is added to a toilet tank, or as an attachment to a toilet bowl, which slowly releases bacteria and enzyme-enriched treatment into the septic system with each flush.

### Related Art

Onsite sewage facilities (OSSF also called septic systems, are wastewater systems designed to treat and dispose of effluent on the same property that produces the wastewater, in areas not served by public sewage infrastructure. A septic tank and drain field combination is a fairly common type of on-site sewage facility in the Western world.¹ Septic systems require a certain concentration of bacteria and enzymes within the system for waste to properly break down and to prevent the system from experiencing any blockage. For most homeowners, to achieve an effective number of bacteria and enzymes, they may need to use a monthly septic tank treatment. This septic tank treatment can be a powder, a liquid, or a gel. An example of a septic tank treatment is RiD-X®, manufactured by reckitt®, located at 399 interpace Parkway, Parsippany, N.J. 07054. Such septic tank treatments replenish bacteria and enzymes in septic systems, and prevent septic systems from backing up and producing odors. ¹ Onsite sewage facility, 13 Apr. 2022. Retrieved 16 Apr. 2022. http://en.wikipedia.org/wiki/Onsite sewate facility

However, using a septic tank treatment requires a conscious effort by the homeowner to remember to routinely treat the septic system. Unfortunately, homeowners often miss treatments and /or entirely forgo to supply their septic systems with septic tank treatments due to the inconvenience of conventional septic tank treatment methods. When homeowners forget or decline to provide such treatment to their septic systems, or even in between routine treatments, wastes can buildup. This buildup of waste can cause severe damage to the septic systems. If damage occurs, costs to repair or replace the septic systems can be high. Additionally, a damaged or malfunctioning septic system may result in flooding and damage to other parts of the home. Furthermore, a damaged or malfunctioning septic system can release incompletely treated effluent into the environment, adversely affecting aquatic ecosystems in particular. Also, a damaged or malfunctioning septic system can be directly unhealthy to the occupants of the home, especially if effluent backs up sufficiently to stand in a recreational space such as a back yard. Thus, it is imperative that homeowners routinely use a septic tank treatment.

Another drawback to typical known septic treatments is that they lack a visual means indicating their effectiveness. Moreover, problems with the septic tank may occur when antibacterial hand soaps and other bactericidal compounds enter the septic system as a result of hand washing, showering, clothes washing, or other sources. Specifically, the antibacterial compounds can cause harm to the bacteria and/or enzymes that are needed in septic systems. As a result, these antibacterial soaps can hinder the ability of the septic system to break down waste. This may again result in a buildup of waste which will cause severe damage to the septic system, potentially requiring costly repairs.

ln view of these problems afflicting known devices and methods for treating septic systems, it is clear there is a longstanding unmet need for an improved solution.

### SUMMARY

Embodiments described herein relate to a Septic Aid system and method that addresses the aforementioned concerns. The Septic Aid provides users with a small device added to the water in a toilet tank in the form of a tablet, or which attaches to the edge of the toilet bowl. The tablet is porous and/or slowly dissolvable, and slowly releases bacteria and/or enzyme enriched septic tank treatment into the toilet water, which then proceeds to the septic tank with each flush. The Septic Aid system and method provides homeowners with bacteria and/or enzyme enriched septic tank treatment every time the toilet is flushed, so that forgetting to treat the septic tank is no longer an issue.

The Septic Aid system and method includes a tablet having a composition that includes a bacteria and/or enzyme type of septic treatment, and may also include a color indicator. In embodiments including a color indicator, the color indicator is adapted to fully dissolve in water and to change the color of the water within the toilet bowl to indicate that the bacteria and/or enzyme treatment is entering the septic system. The color indicator may be any color with sufficient contrast. The color indicator is further adapted to run out and no longer show as a visible color at approximately the same time as the septic treatment bacteria and/or enzymes have been depleted. In this way, indication is given by absence of the visible coloration of the water that the tablet needs to be replaced.

The tablet itself may be configured to fully dissolve, so that once the septic treatment bacteria andior enzymes have been depleted, and the color indicator has fully dissolved, nothing remains of the tablet. Alternatively, the tablet may be configured with a porous substrate, such as for non-limiting example a mineral substrate like pumice or similar material, so that once the septic treatment bacteria and/or enzymes have been depleted, and the color indicator has fully dissolved, the tablet itself remains intact for disposal. In still another embodiment, the tablet may be in gel or gummy form. In yet another embodiment, the tablet may be in tablet-shaped container farm, with gel or liquid septic treatment bacteria and/or enzymes therein, and having tiny perforations or permeable areas that allow the septic treatment bacteria and/or enzymes, and color indicator if used, to leach into the toilet water.

The tablet may be secured within a toilet bowl by way of adhesive, suction cup, or other adherent, or by way of a hangar arrangement. Alternatively, the tablet may be placed in the toilet tank, or secured to the interior of the toilet tank by way of adhesive, suction cup, or other adherent, or by way of a hangar arrangement. If a hangar arrangement is used, the hangar may be made from any rigid metal, plastic, waterproof biodegradable cardboard, or other suitable material. Alternately, all of the hangar arrangement, or a portion thereof, may also be dissolvable. In such an embodiment, the hangar arrangement may be formed of a composition similar to the dissolvable tablet, except that it may be hardened or otherwise modified to ensure that the hangar arrangement does not dissolve before the tablet is substantially or fully dissolved or depleted. Similarly, any packaging may also be dissolvable, so that the tablet is put in place with the packaging intact, which packaging dissolves allowing water to contact the tablet. In any such arrangement, the tablet then delivers a dose of the septic treatment bacteria and/or enzymes to the septic system each time the toilet is flushed. In an embodiment wherein the hangar arrangement is formed of a composition similar to the tablet, the remaining hangar portion may be thrown into the toilet tank to finish dissolving when the Septic Aid is replaced. The tablet may be scented or unscented.

in another embodiment of the Septic Aid system and method, the tablet having the composition including the bacteria and/or enzyme type of septic treatment, and also possibly including the color indicator, may be shrouded by a child-safe enclosure or shield. In such an embodiment, the tablet may be reduced in size. The child-safe enclosure or shield may be open towards the underside of the tablet, so that water interfaces with the tablet, or the child-safe enclosure or shield may otherwise be perforated or have permeable areas.

In another embodiment of the Septic Aid system and method, two tablets may be provided, one having the bacteria septic treatment, and the other having the enzyme septic treatment. The two tablets may be applied together in one location, such as in the toilet tank or in the toilet bowl, or one tablet may be applied in the toilet tank and the other in the toilet bowl. In this way, manufacturing techniques friendly to either the bacteria or to the enzymes may be employed without interfering with the other.

The Septic Aid system and method is designed for homeowners and lessors to maintain waste levels and septic tank health within the septic system. The Septic Aid system and method further offers an easy, mess-free solution to break down wastes that have a tendency to back-up if left untreated, while avoiding the need to remember the most recent application of septic treatment, or to follow a rigid schedule in order to prevent buildup between uses. The Septic Aid system and method dyes the color of the toilet water so that residents are able to easily determine when the product needs to be changed. The Septic Aid system and method further helps to eliminate high costs associated with septic system replacement and flooding.

According to one embodiment of the Septic Aid, a system includes a tablet containing dissolvable bacteria and/or enzyme septic treatment. The tablet is configured to slowly release the dissolvable bacteria and/or enzyme septic treatment into toilet water. The dissolvable bacteria and/or enzyme septic treatment is so constituted as to supply a septic system with replacement bacteria and/or enzymes.

According to another embodiment of the Septic Aid, a tablet of a system contains dissolvable bacteria and/or enzyme septic treatment. The dissolvable bacteria and/or enzyme septic treatment is compressed, compacted, and/or adhered in the form of a tablet, and is configured to slowly release the dissolvable bacteria and/or enzyme septic treatment into toilet water. The dissolvable bacteria and/or enzyme septic treatment is so constituted as to supply a septic system with replacement bacteria and/or enzymes.

According to yet another embodiment of the Septic Aid, a method of maintaining a septic system includes several steps. The first step is providing a tablet containing dissolvable bacteria and/or enzyme septic treatment. The second step is configuring the tablet to slowly release the dissolvable bacteria and/or enzyme septic treatment into toilet water. The third step is so constituting the dissolvable bacteria and/or enzyme septic treatment as to supply a septic system with replacement bacteria and/or enzymes.

### DESCRIPTION OF THE DRAWINGS

The above-mentioned and other features of embodiments of the Septic Aid, and the manner of their working, will become more apparent and will be better understood by reference to the following description of embodiments of the Septic Aid taken in conjunction with the accompanying drawings, wherein:

FIG. 1 shows a perspective view of a home septic system, as described herein;

FIGS. 2A, 2B, and 2C show perspective views of alternative embodiments of the Septic Aid system and method, as described herein;

FIG. 3 shows a partial perspective view of an embodiment of the Septic Aid system and method placed within the interior of a toilet water tank, as described herein;

FIGS. 4 and 5 show partial perspective views of embodiments of the Septic Aid system and method secured to the interiors of toilet bowls, as described herein' and

FIGS. 6A and 6B show perspective views of alternative embodiments of the Septic Aid system and method, as described herein.

Corresponding reference numbers indicate corresponding parts throughout the several views. The exemplifications set out herein illustrate embodiments of the Septic Aid, and such exemplifications are not to be construed as limiting the scope of the claims in any manner.

### DETAILED DESCRIPTION

The following detailed description d appended drawing describe and illustrate various exemplary embodiments of the invention. The description and drawings serve to enable one skilled in the art to make and use the invention, and are not intended to limit the scope of the invention in any manner. In respect of any methods disclosed and illustrated, the steps presented are exemplary in nature, and thus, the order of the steps is not necessary or critical.

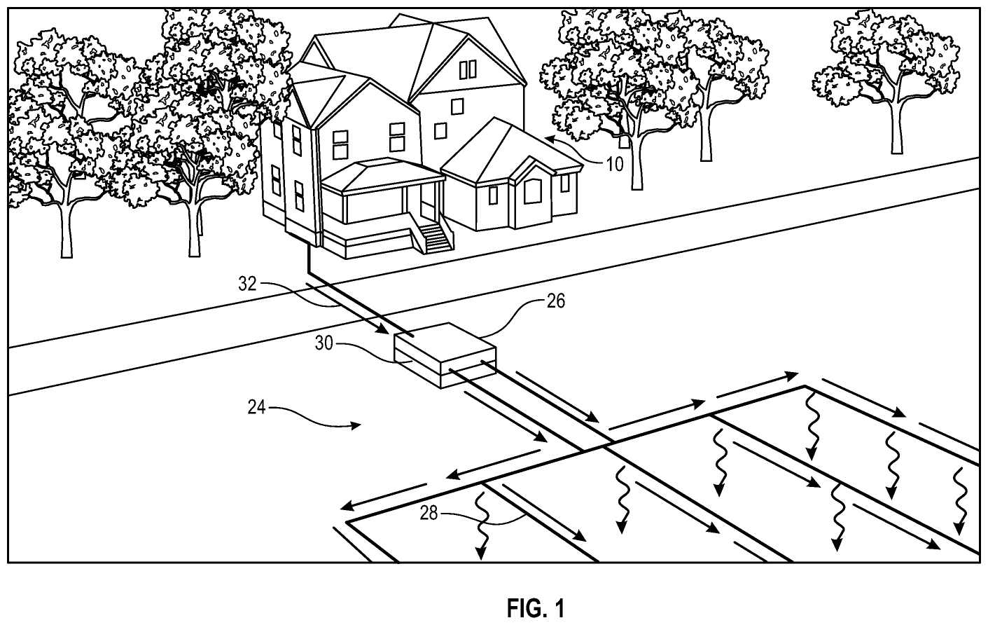

Referring now to FIG. 1, there is shown a perspective view of an embodiment of a home septic system 24 connected to a home 10. The home septic system 24 is provided with a septic tank 26 and a drain field 28. Effluent 32 originates from within the home 10, including from sink drains, toilets, washing machines, and tubs, for non-limiting example. This effluent 32 may have compounds in it that are detrimental to the naturally occurring bacteria and/or enzymes within the septic tank 26 and drain field 28, including for non-limiting example antibacterial hand, dish, and laundry soap with bactericidal compounds, drain clearing acids, bleach, ammonia, softener salt, and etcetera.

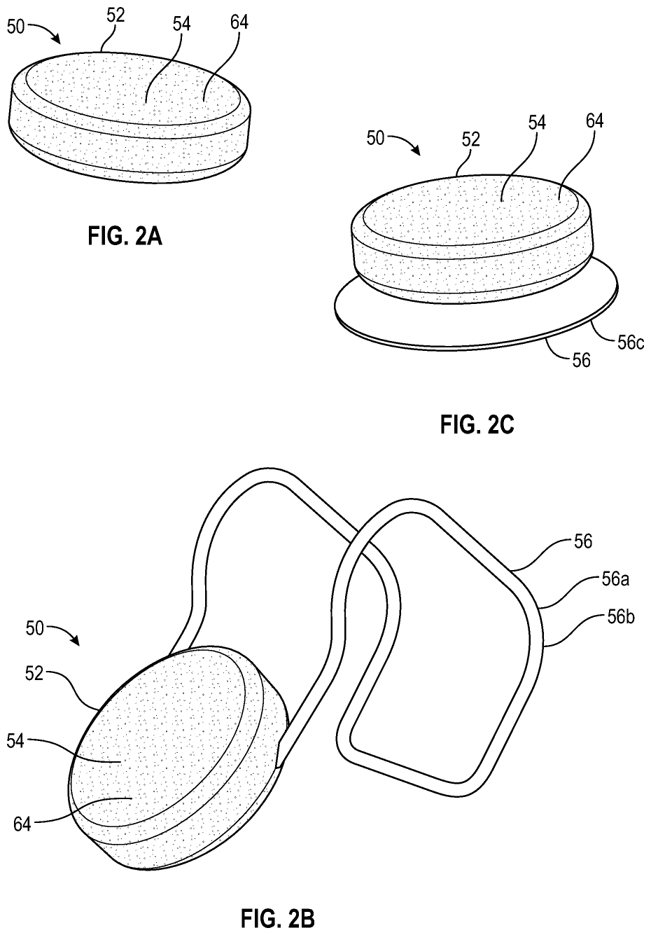

Turning now to FIGS. 2A, 2, and 2C there is shown perspective views of alternative embodiments of the Septic Aid home septic treatment system 50. The home septic treatment system 50 includes a tablet 52 and may include an attachment 56. The tablet 52 has a composition that includes a bacteria and/or enzyme septic treatment 54, and may also be provided with a color indicator 64. In the embodiment of the home septic treatment system 50 shown in FIG. 2A, no attachment is provided. In such an embodiment, the tablet 52 is placed within the rear tank of a toilet (not shown). Once the tablet 52 is positioned at the bottom of the rear tank, the tablet 52 and the bacteria and/or enzyme e septic treatment 54 and any color indicator 64 within the tablet 52, or just the bacteria and/or enzyme septic treatment 54 and any color indicator 64 within the tablet 52, slowly dissolves into the toilet water over time.

In this way, a small amount of the bacteria and/or enzyme septic treatment 54 is released from the tablet 52 with each flush of the toilet as the tablet 52 and/or its bacteria and/or enzyme septic treatment 54 content dissolves. The bacteria and/or enzyme septic treatment 54 then enters the septic system and breaks down waste to prevent the septic system 24 from experiencing any blockage. The color indicator 64 is also adapted to dissolve in water. The color indicator 64 changes the color of the water within the toilet tank to indicate that the bacteria and/or enzyme septic treatment 54 is entering the septic system 24. When the tablet 52 is depleted of the bacteria and/or enzyme septic treatment 54, the color from the color indicator 64 will no longer be visible. When the color is no longer visible, the home septic treatment system 50 requires replacement.

In the embodiment of the home septic treatment system 50 shown in FIG. 2B, an attachment is provided in the form of a hangar arrangement 56a arranged as a wireframe 56b. The hanger arrangement 56a is connected to the tablet 52 and is composed of a rigid material such as metal, plastic, waterproof biodegradable cardboard, or other suitable material. Alternately, as mentioned previously, all of the hangar arrangement 56a, or a portion thereof, may be formed of a dissolvable composition similar to the dissolvable tablet 52, except that it may be hardened or otherwise modified to ensure that the hangar arrangement does not dissolve before the tablet 52 is substantially or fully dissolved or depleted. The hangar arrangement 56a is configured to secure the home septic treatment system 50 to the edge of a toilet bowl so that the tablet 52 is in contact with the interior of the toilet bowl. Similarly, in the embodiment of the home septic treatment system 50 shown in FIG. 2C, an attachment is provided in the form of an adherent base 56c. The adherent base 56c may be a suction cup or an adhesive disc, for non-limiting example.

in either of the embodiments of FIGS. 2B and 2C, a small amount of the bacteria and/or enzyme septic treatment 54 is again released from the tablet 52 with each flush of the toilet as the tablet 52 and/or its bacteria and/or enzyme septic treatment 54 content dissolves into the water flushing past the tablet 52. The color indicator 54 changes the color of the water within the toilet bowl to indicate that the bacteria and/or enzyme septic treatment 54 is entering the septic system 24. As before, when the tablet 52 is depleted of the bacteria and/or enzyme septic treatment 54, the color from the color indicator 64 will no longer be visible. When the color is no longer visible, the home septic treatment system 50 requires replacement.

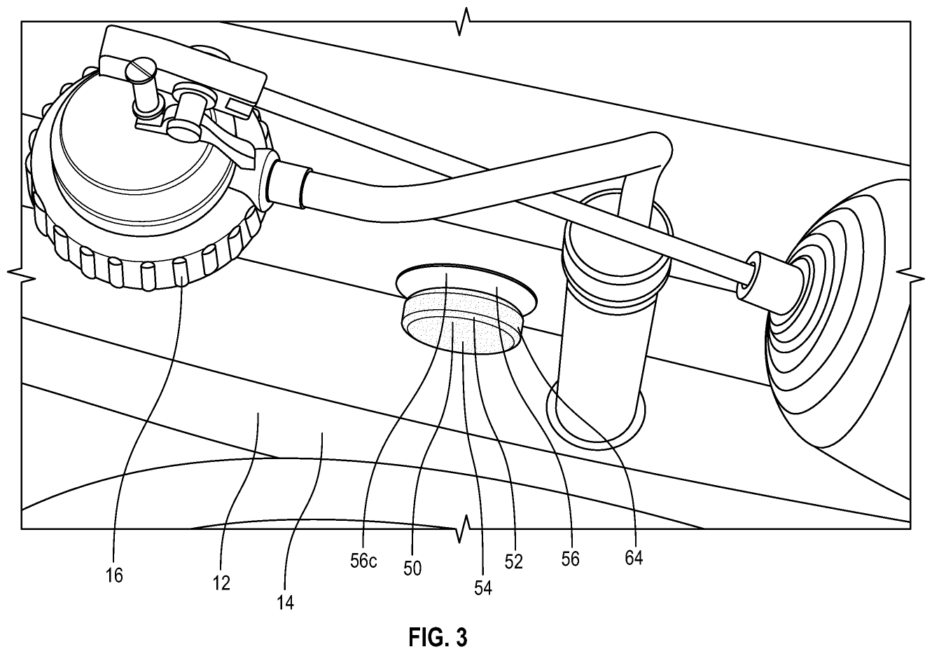

FIG. 3 shows a partial perspective view of an embodiment of the Septic Aid home septic treatment system 50 placed within the interior of a toilet water tank 14 of a toilet 12. The toilet water tank 14 is provided with a toilet tank fill mechanism 16. The tablet 52 containing the bacteria and/or enzyme septic treatment 54 and in some embodiments the color indicator 64 is attached to the interior of the toilet water tank 14 by way of the attachment 56 in the form of an adherent base 56c Alternately, it is contemplated that the tablet 52 may be attached to the interior of the toilet water tank 14 using an attachment in the form of a hangar arrangement, in addition to simply being placed at the bottom of the toilet water tank 14.

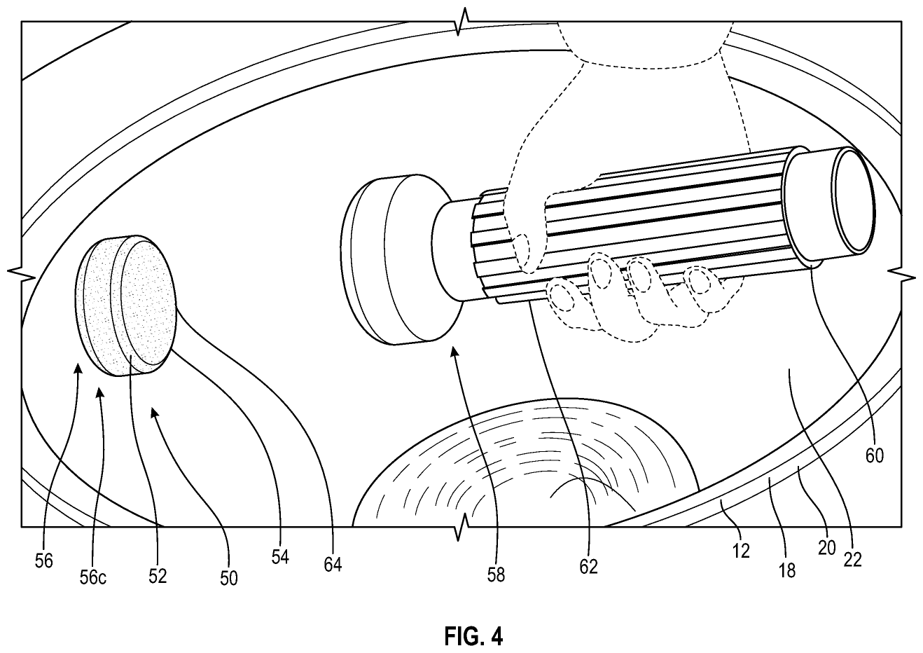

FIG. 4 shows a partial perspective view of an embodiment of the Septic Aid home septic treatment system 50 with the tablet 52 placed upon the toilet bowl interior surface 22 of a toilet bowl 18 of a toilet 12, beneath the toilet bowl edge 20. An attachment 56 in the form of an adherent base 56c is used to hold the tablet 52 in place upon the toilet bowl interior surface 22, so that bacteria and/or enzyme septic treatment 54 and color indicator 64 is released with every flush of the toilet 12. In order to apply the tablet 52 to the toilet bowl interior surface 22, an applicator 58 is used. The applicator 58 has a receptacle at its end that releasably accommodates the tablet 52 as it is being applied to the toilet bowl interior surface 22. The applicator 58 is further provided with an applicator handle 60 having an applicator grip 62 for easy and secure manipulation.

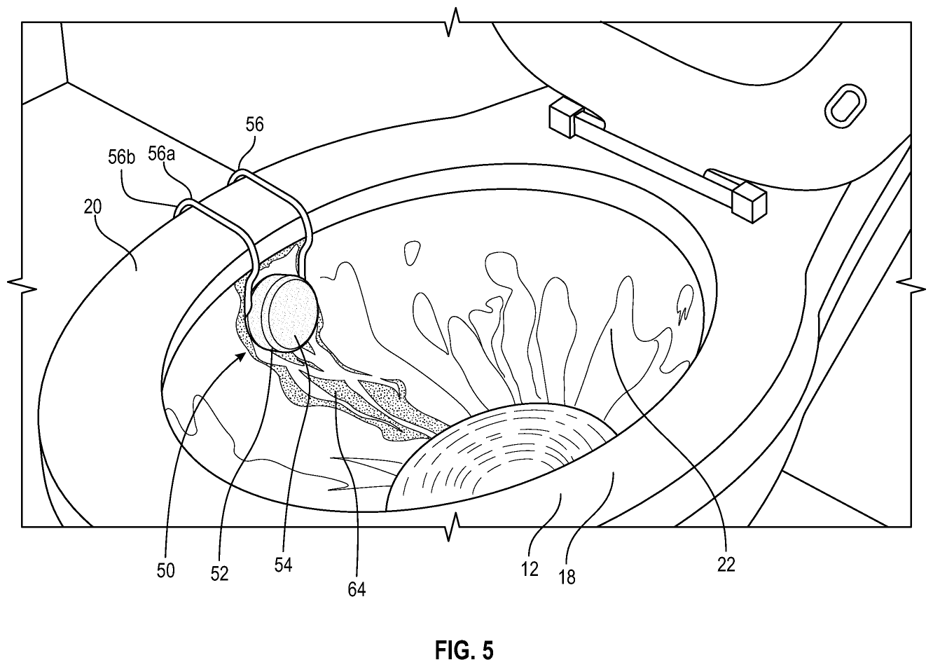

FIG. 5 shows a partial perspective view of another embodiment of the Septic Aid home septic treatment system 50 with the tablet 52 placed upon the toilet bowl interior surface 22 of a toilet bowl 18 of a toilet 12, beneath the toilet bowl edge 20. An attachment 56 in the form of a hangar arrangement 56a arranged as a wireframe 56battaches to the toilet bowl edge 20, and is shaped to hold the tablet 52 in place upon the toilet bowl interior surface 22, so that bacteria and/or enzyme septic treatment 54 and color indicator 64 is again released with every flush of the toilet 12.

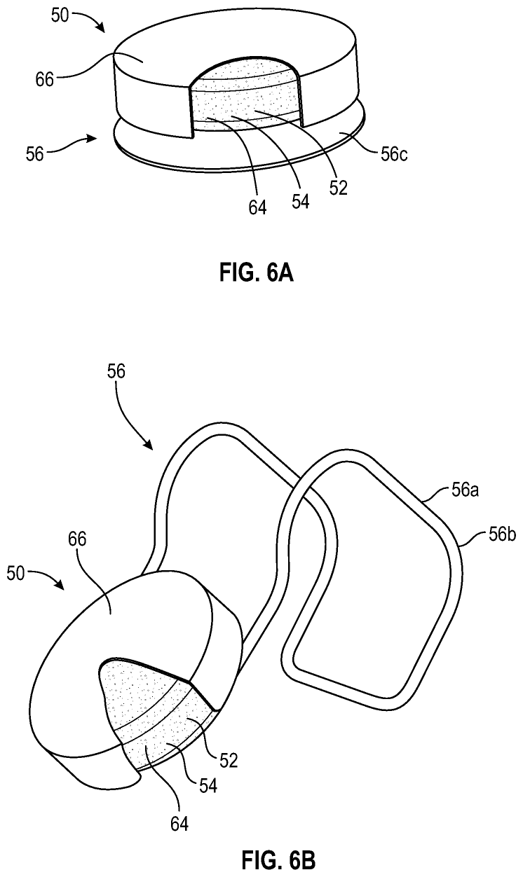

FIGS. 6A and 6B show perspective views of additional embodiments of the Septic Aid/home septic treatment system 50, similar to the embodiments of the Septic Aid/home septic treatment system 50 shown in FIGS. 2C and 2B, respectively. Tablets 52 are again provided with bacteria and/or enzyme septic treatment 54 and may be provided with color indicator 64. The tablets 52 may again be positioned within the toilet water tank of a toilet (not shown) or upon the toilet bowl interior surface of a toilet bowl of a toilet (not shown), using attachments 56, so that bacteria and/or enzyme septic treatment 54 and color indicator 64 is again released with every flush of the toilet 12. The attachments 56 may be configured as a hangar arrangement 56a arranged as a wireframe 56b, or may be configured as an adherent base 56c,

In each of the embodiments of the Septic Aid/home septic treatment system 50 shown in FIGS. 6A and 6B, the tablet 52 is enshrouded within a child safe enclosure or shield 66, which may be attached to the attachment 56 or to the tablet 52 itself, in particular if the tablet itself remains intact after the bacteria and/or enzyme septic treatment 54 and color indicator 64 have dissolved. The child-safe enclosure or shield 66 may be open towards the underside of the tablet 52, so that water interfaces with the tablet 52, or the child-safe enclosure or shield 66 may otherwise be perforated or have permeable areas.

While the Septic Aid has been described with respect to at least one embodiment, the Septic Aid can be further modified within the spirit and scope of this disclosure, as demonstrated previously. This application is therefore intended to cover any variations, uses, or adaptations of the Septic Aid using its general principles. Further, this application is intended to cover such departures from the present disclosure as come within known or customary practice in the art to which the disclosure pertains and which fall within the limits of the appended claims.

### REFERENCE NUMBER LISTING

10 home
12 toilet
14 toilet water tank
16 toilet tank fill mechanism
18 toilet bowl
20 toilet bowl edge
22 toilet bowl interior surface
24 septic system
26 septic tank
28 drain field
30 waste level
32 effluent
50 Septic Aid/home septic treatment system
52 tablet
54 bacteria and/or enzyme septic treatment attachment
56a hangar arrangement
56bwireframe
56c adherent base
58 applicator
60 applicator handle
62 applicator grip
64 color indicator
66 child safe enclosure or shield

What is claimed is:

1. A Septic Aid system, comprising:
at least one tablet containing dissolvable bacteria and/or enzyme septic treatment, the at least one tablet being configured to slowly release the dissolvable bacteria and/or enzyme septic treatment into toilet water, the dissolvable bacteria and/or enzyme septic treatment so constituted as to supply a septic system with replacement bacteria and/or enzymes.

2. The Septic Aid system of claim 1, wherein:
the at least one tablet further contains dissolvable color indicator, the dissolvable color indicator being configured to run out at approximately the same time as the dissolvable bacteria and/or enzyme septic treatment is depleted.

3. The Septic Aid system of claim 1, wherein:
the at least one tablet is one of:
entirely dissolvable along with the dissolvable bacteria and/or enzyme septic treatment,
provided with a non-dissolvable porous substrate containing the dissolvable bacteria and/or enzyme septic treatment,
provided in gel or gummy form containing the dissolvable bacteria and/or enzyme septic treatment.

4. The Septic Aid system of claim 1, wherein:
the at least one tablet is contained within a tablet-shaped container having pet ions or permeable areas.

5. The Septic Aid system of claim 1, wherein:
the at least one tablet is connected to an attachment, the attachment being one of:
an adhesive disc,
a suction cup,
a hangar arrangement.

6. The Septic Aid system of claim 5, wherein:
the hangar arrangement being one of:
formed as a wireframe, and
at least partially formed of a composition similar to the dissolvable tablet and/or the dissolvable bacteria and/or enzyme septic treatment, further being hardened such that the hangar arrangement does not dissolve before the at least one tablet is substantially or fully dissolved or depleted.

7. The Septic Aid system of claim 1, further comprising:
an applicator having a receptacle at one end that releasably accommodates the at least one tablet as it is being applied to a toilet bowl interior surface, the applicator being provided with an applicator handle having an applicator grip.

8. The Septic Aid system of claim 1, further comprising:
a child-safe enclosure or shield connected to the at least one tablet, the child-safe enclosure or shield one of:
open towards the underside of the at least one tablet,
at least partially perforated, and
having permeable areas.

9. A tablet of a Septic Aid system, comprising:
dissolvable bacteria and/or enzyme septic treatment compressed, compacted, and/or adhered in the form of a tablet, and configured to slowly release the dissolvable bacteria and/or enzyme septic treatment into toilet water, the dissolvable bacteria and/or enzyme septic treatment so constituted as to supply a septic system with replacement bacteria and/or enzymes.

10. The tablet of claim 9, further comprising:
dissolvable color indicator mixed into the dissolvable bacteria and/or enzyme septic treatment, the dissolvable color indicator being configured to run out at approximately the same time as the dissolvable bacteria and/or enzyme septic treatment is depleted.

11. The tablet of claim 9, wherein:
the tablet is one of:
entirely dissolvable along with the dissolvable bacteria and/or enzyme septic treatment,
provided with a non-dissolvable porous substrate containing the dissolvable bacteria and/or enzyme septic treatment,
provided in gel or gummy form containing the dissolvable bacteria and/or enzyme septic treatment.

12. The tablet of claim 9, further comprising:
an attachment connected to the tablet, the attachment being one of:
an adhesive disc,
a suction cup,
a hangar arrangement, the hangar arrangement being one of:
formed as a wireframe, and
at least partially formed of a composition similar to the dissolvable tablet and/or the dissolvable bacteria and/or enzyme septic treatment, further being hardened such that the hangar arrangement does not dissolve before the tablet is substantially or fully dissolved or depleted.

13. The tablet of claim 9, further comprising:
a child-safe enclosure or shield connected to the tablet, the child-safe enclosure or shield one of:
open towards the underside of the tablet,
at least partially perforated, and
having permeable areas.

14. A method of maintaining a septic system, comprising the steps of:
providing at least one tablet containing dissolvable bacteria and/or enzyme septic treatment;
configuring the at least one tablet to slowly release the dissolvable bacteria and/or enzyme septic treatment into toilet water; and
so constituting the dissolvable bacteria and/or enzyme septic treatment as o supp septic system with replacement bacteria and/or enzymes.

15. The method of claim 14, further comprising the steps of:
further providing the at least one tablet with dissolvable color indicator; and
configuring the dissolvable color indicator to run out at approximately the same time as the dissolvable bacteria and/or enzyme septic treatment is depleted.

16. The method of claim 14, wherein:
the at least one tablet is one of:
entirely dissolvable along with the dissolvable bacteria and/or enzyme septic treatment,
provided with a non-dissolvable porous substrate containing the dissolvable bacteria and/or enzyme septic treatment,
provided in, gel or gummy form containing the dissolvable bacteria and/or enzyme septic treatment

17. The method of claim 14, wherein:
the at least one tablet is contained within a tablet-shaped container having perforations or permeable areas.

18. The method of claim 14, further comprising the steps of:
connecting the at least one tablet to an attachment, the attachment being one of:
an adhesive disc,
a suction cup,
a hangar arrangement, the hangar arrangement being one of
formed as a wireframe, and
at least partially formed of a composition similar to the dissolvable tablet and/or the dissolvable bacteria and/or enzyme septic treatment, further being hardened such that the hangar arrangement does not dissolve before the at least one tablet is substantially or fully dissolved or depleted.

19. The method of claim 14, further comprising the steps of:
providing an applicator having a receptacle at one end that releasably accommodates the at least one tablet as it is being applied to a toilet bowl interior surface, the applicator being provided with an applicator handle having an applicator grip.

20. The method of claim 14, further comprising the steps of:
connecting a child-safe enclosure or shield to the at least one tablet, the child-safe enclosure or shield one of:
open towards the underside of the at least one tablet,
at least partially perforated, and
having permeable areas.
